(19) United States
(12) Patent Application Publication
(10) Pub. No.: US 2009/0281668 A1
(43) Pub. Date: Nov. 12, 2009

(54) GEOTHERMAL AND REMEDIATION SYSTEM AND METHOD

(75) Inventors: Clay G. Nesler, Brookfield, WI (US); Jeffrey R. Werwie, Racine, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/435,966

(22) Filed: May 5, 2009

Related U.S. Application Data
(60) Provisional application No. 61/052,074, filed on May 9, 2008.
(60) Provisional application No. 61/059,664, filed on Jun. 6, 2008.

(51) Int. Cl. G05D 23/00; F24J 3/08; F28F 27/00; E04B 1/00; B09C 1/06

(52) U.S. Cl. 700/276; 165/45; 165/200; 52/741.1; 405/128.4

(57) ABSTRACT

A method of treating contaminated ground water and controlling the temperature of a building includes pumping water to be remediated from a well to ground level and treating the water with water remediation equipment. The method further includes providing the water to a heat pump to serve as a heat source or a heat sink. The water is then discharged. A geothermal heat pump and water remediation system includes a well used as a source of water, a water remediation system configured to treat the water, and a heat pump configured to heat or cool a building where the heat pump uses the water as at least one of a heat source or a heat sink.

### CROSS-REFERENCE TO RELATED PATENT APPLICATIONS

This application claims the benefit of U.S. Application No. 61/052,074, filed May 9, 2008, incorporated herein by reference in its entirety. This application also claims the benefit of U.S. Application No. 61/059,664, filed Jun. 6, 2008, incorporated herein by reference in its entirety.

### BACKGROUND

The present disclosure relates generally to the field of geothermal heating and cooling and to the field of water remediation. The disclosure relates more specifically to geothermal heating and cooling systems used in combination with remediation systems.

### SUMMARY

The invention relates to a method of treating contaminated ground water and controlling the temperature of a building. The method includes the steps of providing water remediation equipment and a heat pump, pumping water to be remediated from a well to ground level, and treating the water with the water remediation equipment. The method further includes the steps of providing the water to the heat pump to serve as a heat source or a heat sink, and discharging the water.

The invention further relates to a method of retrofitting building equipment and a water remediation system to reduce the cost of operating the building equipment. The method includes the steps of providing water piping, coupling the water piping to a water remediation system used to treat contaminated water, coupling the water piping to the building equipment, and retrofitting the building equipment to use the water as at least one of a heat source or a heat sink.

The invention further relates to a geothermal heat pump and water remediation system. The geothermal heat pump and water remediation system includes a well used as a source of water, a water remediation system configured to treat the water, and a heat pump configured to heat or cool a building. The heat pump uses the water as a heat source or a heat sink.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a partial cut-away perspective view of a building system including wells for pumping groundwater according to an exemplary embodiment.

FIG. 2 is a schematic diagram of the system of FIG. 1 using pumped water to heat or cool the building and discharging remediated water to a groundwater layer according to an exemplary embodiment.

FIG. 3 is a schematic diagram of the system of FIG. 1 using pumped water to heat or cool the building and discharging remediated water to a well according to an exemplary embodiment.

FIG. 4 is a schematic diagram of the system of FIG. 1 using pumped water to heat or cool the building and discharging remediated water to a treatment facility according to an exemplary embodiment.

FIG. 5 is a schematic diagram of the system of FIG. 1 using remediated water to heat or cool the building according to an exemplary embodiment.

FIG. 6 is a schematic diagram of the system of FIG. 1 using pumped water to cool or heat equipment or a process in the building according to an exemplary embodiment.

FIG. 7 is a schematic diagram of the system of FIG. 1 using pumped water to heat or cool the building without an additional heat pump according to an exemplary embodiment.

FIG. 8 is a schematic diagram of the system of FIG. 1 using a heat exchanger in a remediation pond to heat or cool the building according to an exemplary embodiment.

FIG. 9 is a schematic diagram of the system of FIG. 1 using a heat exchange loop in a well to heat or cool the building according to an exemplary embodiment.

FIG. 10 is a perspective view of the system of FIG. 8 including a heat exchanger in a remediation pond coupled to the building according to an exemplary embodiment.

FIG. 11 is a schematic diagram of a geothermal heating and cooling system according to an exemplary embodiment.

FIG. 12 is a schematic diagram of a heat pump according to an exemplary embodiment.

FIGS. 13-17 are process flow diagrams illustrating methods for converting a remediation system to be capable of geothermal heating and cooling according to exemplary embodiments.

FIGS. 18-19 are process flow diagrams illustrating methods for converting a geothermal heating and cooling system to be capable of water remediation according to exemplary embodiments.

FIG. 20 is a schematic diagram of the system of FIG. 1 using pumped water to cool or heat equipment or a process in the building and using remediated water in other building equipment or processes before discharging, according to an exemplary embodiment.

FIG. 21 is a schematic diagram of the system of FIG. 1 using pumped water to cool or heat equipment or a process in the building and discharging water to equipment or a process outside the building, according to an exemplary embodiment.

FIG. 22 is a schematic diagram of a building automation system for the building of FIG. 1, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

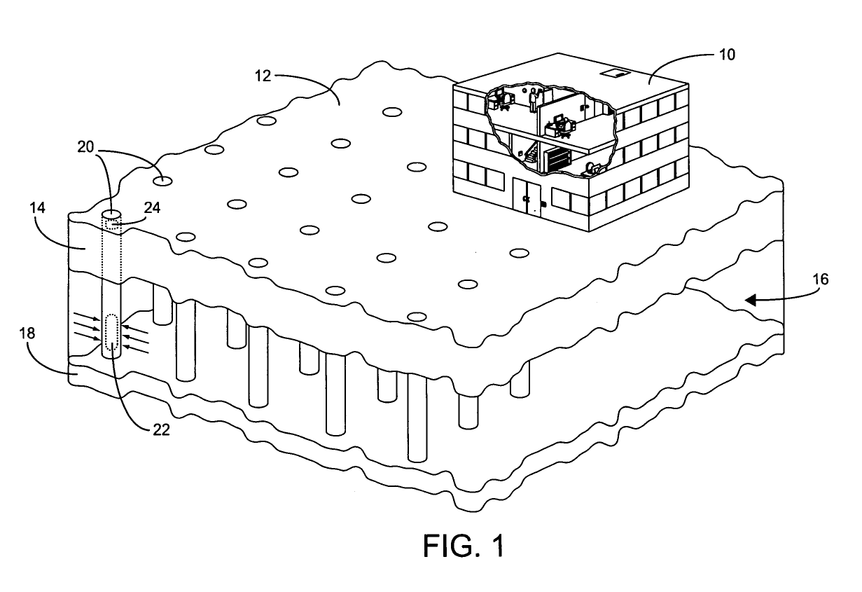

Referring to FIG. 1, a building 10 is located in the area of one or more wells 20. The wells 20 extend from the ground surface 12 through a vadose layer 14, through a groundwater layer 16 and into a bedrock layer 18. According to one exemplary embodiment, the wells 20 may be part of a remediation system 30 to pump groundwater through an inlet 22 for remediation (e.g., to reduce toxins or contaminants in the water, to make the water potable, to contain contaminated water, etc.) by a pump-and-treat process. The water remediation may be conducted in or controlled from within the building.

According to various exemplary embodiments, the well, pump, and treatment may be dependent on the physical site characteristics and contaminant type. Containment may use groundwater pumping as a hydraulic barrier to reduce migration of the contaminated water. Treatment may include one or more processes, for example gravity segregation, air stripping, and carbon systems tailored to remove specific contaminants.

The remediation may include a groundwater monitoring system to verify containment and/or treatment effectiveness. The monitoring system may include piezometers to allow an operator or control system to adjust the system in response to changes in subsurface conditions caused by the remediation. According to one exemplary embodiment, the piezometers may include a small diameter water well used to measure the hydraulic head of the groundwater. According to other exemplary embodiments, the piezometers may include a standpipe, a tube, a vibrating wire piezometer, or a manometer to measure the pressure of a fluid at a specific location in the well.

The remediation system may include one or more of a liquid-phase carbon vessel, an air stripping tower, an oil and water separator, caustic chemicals, a water clarification system, a filtration system, a UV or oxidation system, or any combination thereof.

The remediation system including the wells and building systems may be retrofitted to also facilitate geothermal heat exchange. According to some exemplary embodiments, the wells may pump water to a heat pump for heating and/or cooling air, water, or equipment within the building. According to other exemplary embodiments, heat exchangers may be located within the wells or a discharge location of the remediation system to heat and/or cool air, water, or equipment within the building.

A geothermal heat exchange system transfers heat between a generally constant temperature of the earth or groundwater and the variable temperature of the air, water, or processes of a building. For example, the temperature below the ground surface may only fluctuate within a few degrees throughout the year (e.g., low 50s degrees Fahrenheit (F), mid 40s degrees F., upper 50s degrees F., etc.). This generally stable temperature provides a source for heat and/or a sink to transfer excess heat.

In a geothermal heat exchange system, a fluid may be circulated between the building and piping loops buried in the ground or in a pond. During warmer temperatures, the fluid may collect heat from the building and transfer it to the ground or pond, for example using a heat pump. During cooler temperatures, the fluid may collect heat from the ground and transfer it to the building, for example using a heat pump.

When the temperature inside the building needs to be increased, a geothermal heat exchange system may extract energy from the ground or pond and pump it to the building for concentration by the heat pump. When the building needs cool air, the heat from the building may be concentrated by the heat pump so the system can remove heat from the building and transfer it into the ground or pond. The generally constant temperature of the ground or pond makes the energy transfer efficient during both warm and cool temperatures because heat does not need to be transferred from the building to hotter outdoor air.

According to another exemplary embodiment, the wells 20 may pump water through the inlet 22 with a pump 24 or use the groundwater temperature to facilitate geothermal heat exchange in the building 10 and may be retrofitted to pump and remediate groundwater. According to other exemplary embodiments, the wells 20 may not extend into the bedrock layer 18, but may only extend partially through the groundwater layer 16. According to still other exemplary embodiments, the wells 20 may extend only into the vadose layer 14. While the pump 24 is shown to be located near the ground surface 12 in the well 20, according to other exemplary embodiments, the pump 24 may be located deeper within the well 20, next to the well 20, in the building 10, or in any other location. According to various exemplary embodiments, the pump 24 may be any pump or pumping system capable of pumping water for remediation and/or geothermal heat exchange.

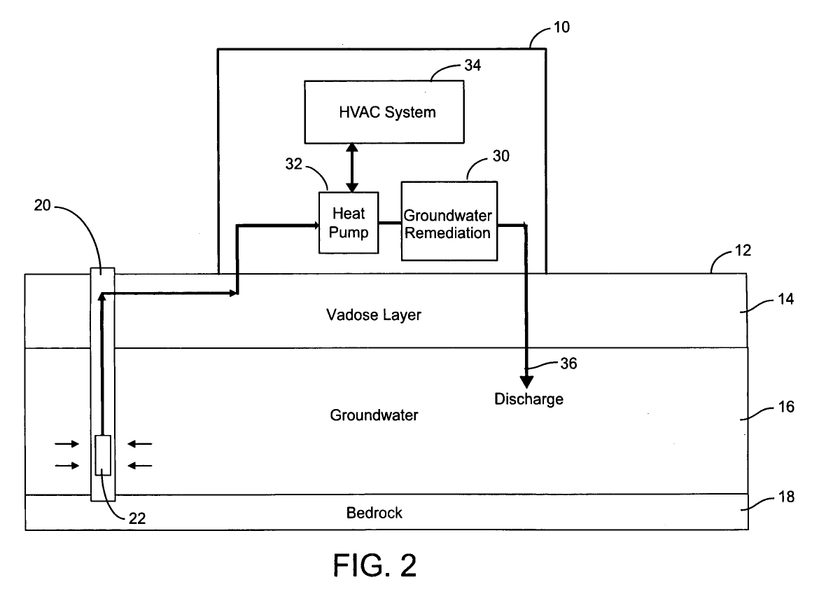

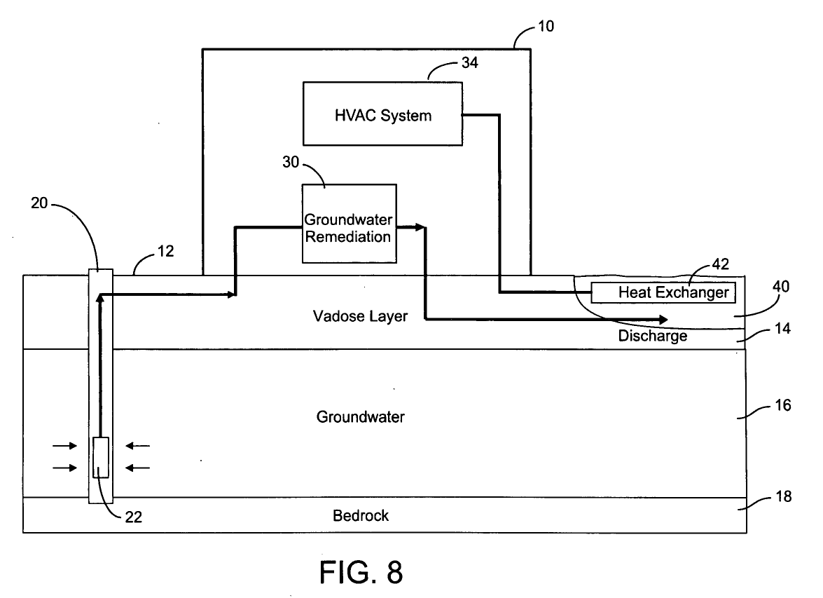

Referring to FIG. 2, pumped water may be used to heat or cool the building 10 and remediated water may be discharged to a groundwater layer 16, according to an exemplary embodiment. The building 10 includes a heat pump 32 coupled to a groundwater remediation system 30 and a heating, ventilation, and air-conditioning (HVAC) system 34. The heat pump 32 receives pumped groundwater from the well 20 and transfers heat to or from the HVAC system 34. The HVAC system 34 may transfer heat from the heat pump 32 to provide heating to the building 10 or may transfer heat to the heat pump 32 to provide cooling to the building 10. Once the pumped water passes through the heat pump 32, it is treated or contained by the groundwater remediation system 30 and discharged back into the groundwater layer 16, for example by discharge onto the ground surface 12, by discharge into a drain or pipe 36 leading to the groundwater layer 16, or by discharge into a pond 40 (FIG. 8).

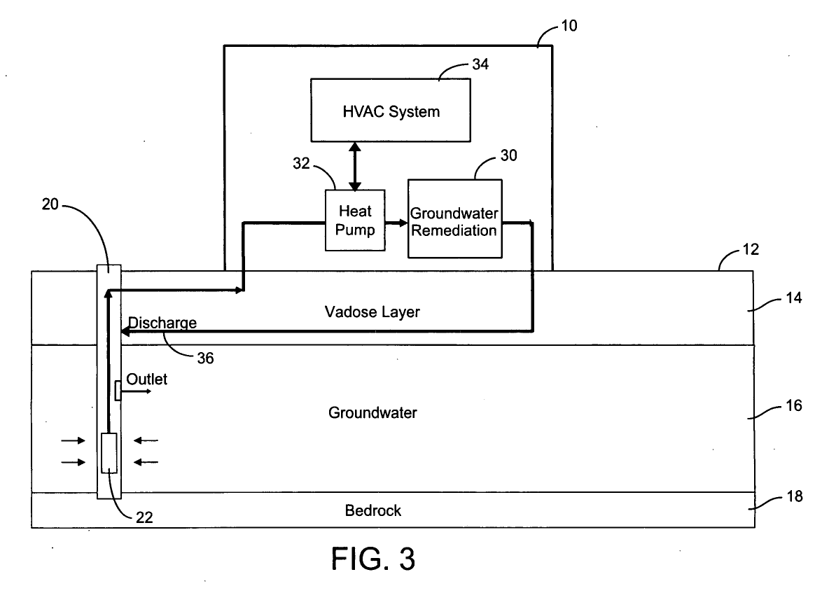

Referring to FIG. 3, pumped water may be used to heat or cool the building 10 similar to as in FIG. 2, but with the remediated water discharged back to a well 20 according to an exemplary embodiment.

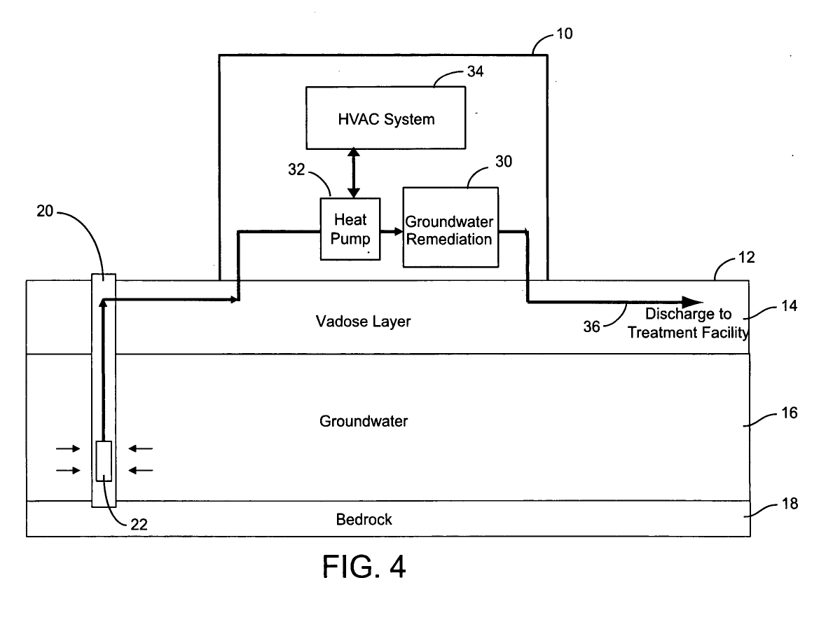

Referring to FIG. 4, pumped water may be used to heat or cool the building 10 similar to as in FIG. 2, but with the remediated water discharged to a treatment facility (e.g., a publicly owned treatment works or testing facility, a private or commercial testing or treatment facility, etc.) according to an exemplary embodiment.

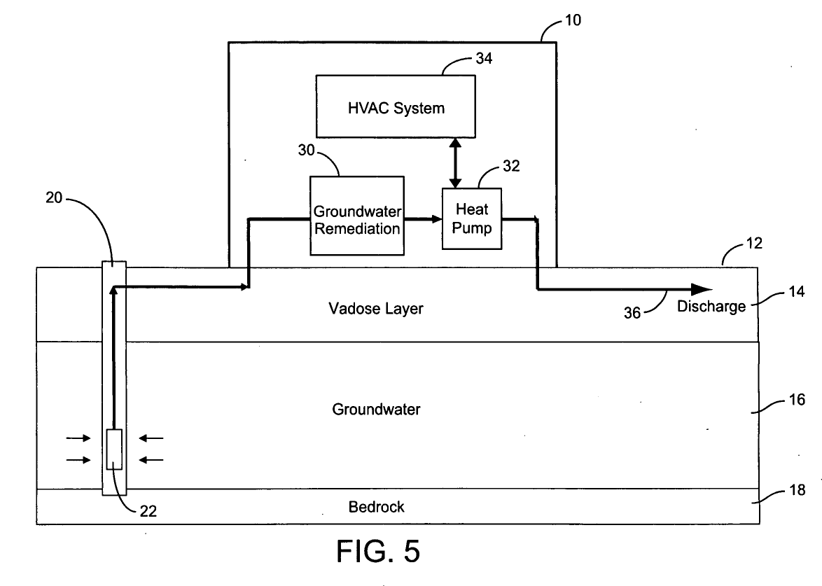

Referring to FIG. 5, pumped water may be used to heat or cool the building 10 according to an exemplary embodiment. The building 10 includes a heat pump 32 coupled to a groundwater remediation system 30 and an HVAC system 34. The water remediation system 30 receives pumped groundwater from the well 20 and transfers treated water to the heat pump 32. The heat pump 32 receives the remediated water from the remediation system 30 and transfers heat to or from the HVAC system 34. The HVAC system 34 may transfer heat from the heat pump 32 to provide heating to the building 10 or may transfer heat to the heat pump 32 to provide cooling to the building 10. Once the remediated water passes through the heat pump 32, it discharged back into the groundwater layer 16, for example by discharge onto the ground surface 12(e.g., into a drain or pipe, back into the well, into a pond, etc.), or to a treatment facility.

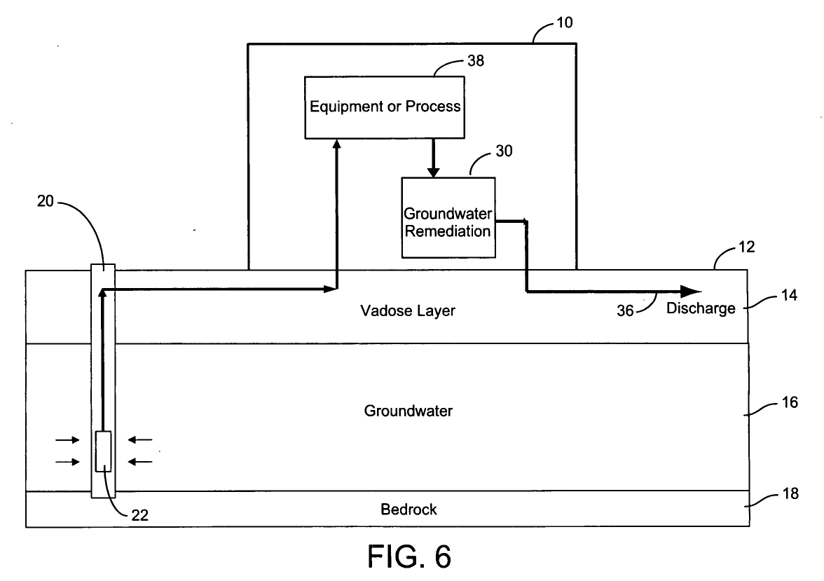

Referring to FIG. 6, pumped water may be used to heat or cool the building 10 according to an exemplary embodiment. The building 10 does not include a heat pump, but the water is pumped directly to equipment or to a process 38 that is to be cooled or heated (e.g., a manufacturing or industrial process, a machine requiring cooling, a battery requiring heating, etc.). The water remediation system 30 receives water from the equipment or process 38 for treatment or containment. Any treated water is discharged back into the groundwater layer 16, for example by discharge onto the ground surface 12 (e.g., into a drain or pipe, back into the well, into a pond, etc.), or to a treatment facility.

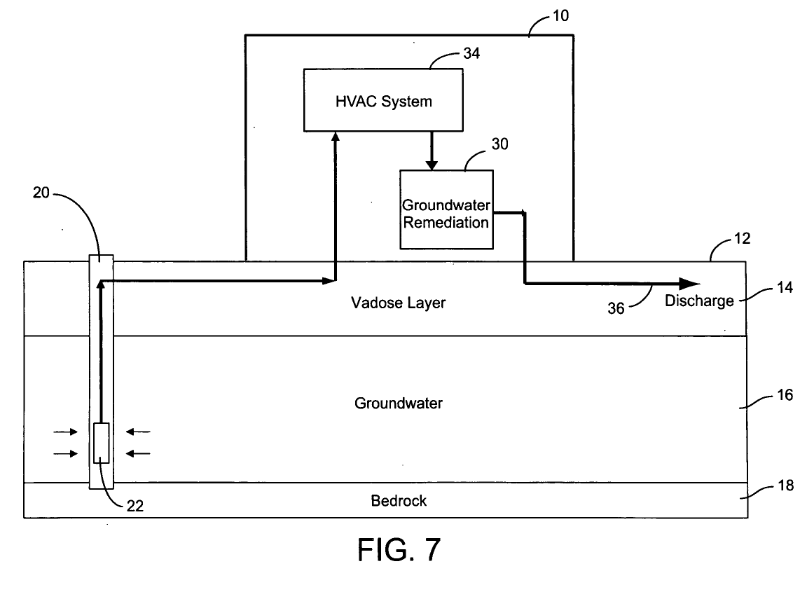

Referring to FIG. 7, pumped water may be used to heat or cool the building 10 according to an exemplary embodiment. The building 10 does not include a heat pump, but the water is pumped directly to an HVAC system 34 that may use the water to cool the building air. The water remediation system 30 receives water from the HVAC system 34 for treatment or containment. Any treated water is discharged back into the groundwater layer 16, for example by discharge onto the ground surface 12 (e.g., into a drain or pipe, back into the well, into a pond, etc.), or to a treatment facility.

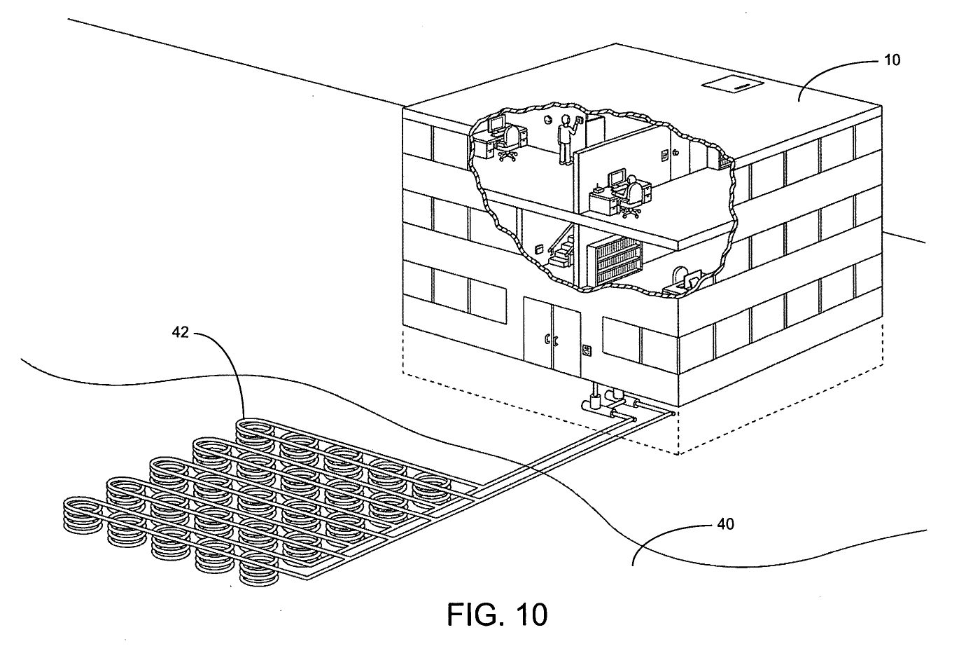

Referring to FIGS. 8 and 10, pumped water may be used to heat or cool the building 10 according to an exemplary embodiment. The building 10 does not include a heat pump, but the water is pumped directly to a remediation system 30 for treatment or containment. Any treated water is discharged into a remediation pond 40. The heat exchanger 42 may include multiple coils or loops filled with a heat transferring fluid to facilitate heat exchange with the discharged water in the pond 40. The HVAC system 34 may transfer heat from the heat exchanger 42 to provide heating to the building 10 or may transfer heat to the heat exchanger 42 to provide cooling to the building 10. According to another exemplary embodiment, a heat pump may circulate fluid through the heat exchanger 42 and transfer heat to or from the HVAC system 34.

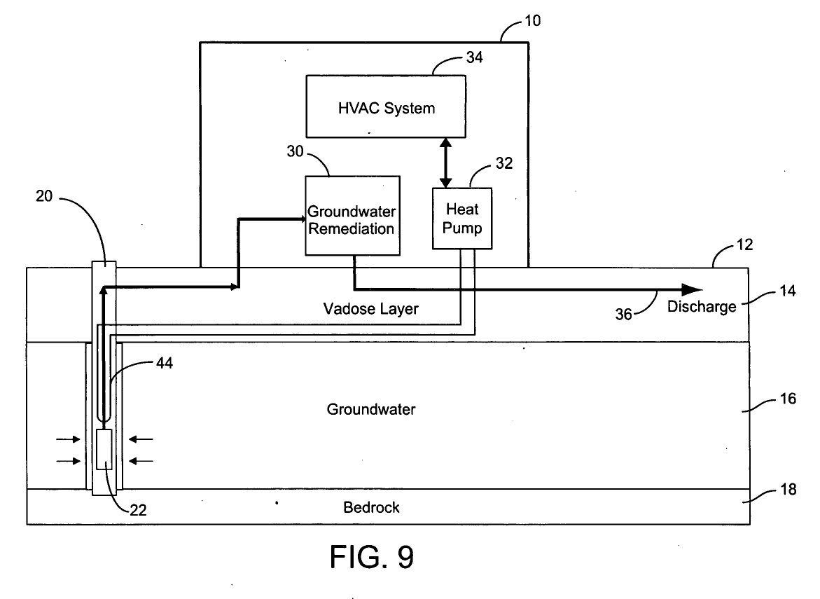

Referring to FIG. 9, pumped water may be used to heat or cool the building 10 according to an exemplary embodiment. The building 10 includes a remediation system 30 that pumps water from the well 20 for treatment or containment and discharges any treated water back into the groundwater layer 16, for example by discharge onto the ground surface 12 (e.g., into a drain or pipe, back into the well, into a pond, etc.), or to a treatment facility. The building 10 also includes a heat pump 32 coupled to a heat exchange loop or coil 44 extending into the well 20 and also coupled to an HVAC system 34. The heat pump 32 uses the heating coil 44 to transfer heat between the HVAC system 34 and the groundwater. The HVAC system 34 may transfer heat from the heat pump 32 to provide heating to the building 10 or may transfer heat to the heat pump 32 to provide cooling to the building 10.

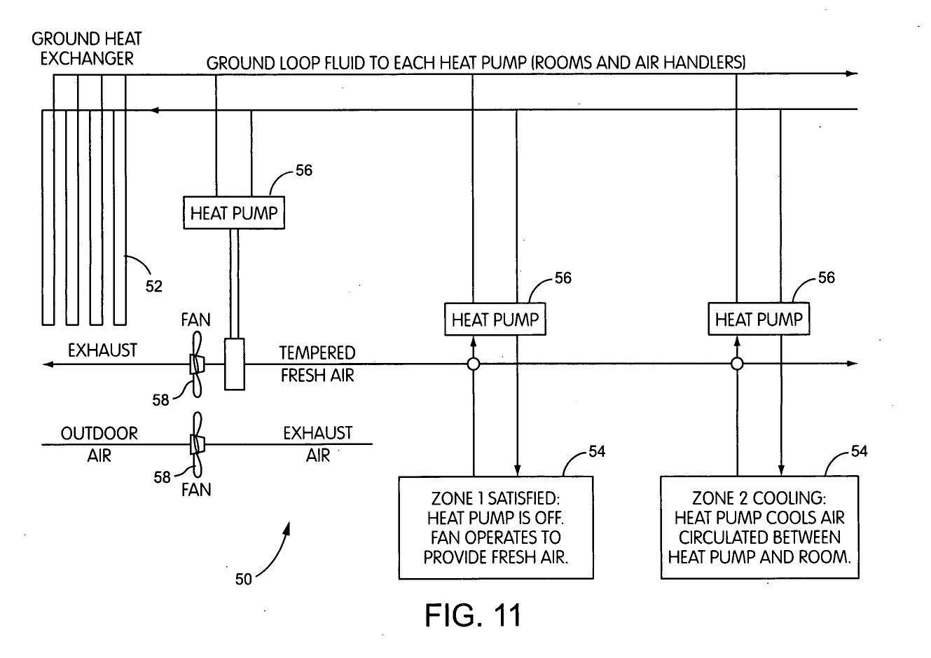

FIG. 11 is a schematic diagram of a geothermal heating and cooling system 50 according to an exemplary embodiment. The ground heat exchanger 52 may include heat exchange loops 44 in wells 20 or a heat exchanger 42 in a remediation pond 40. According to other exemplary embodiments, the ground heat exchanger 52 may be internal to a heat pump 32 with water pumped directly from the wells 20. The building 10 may include one or more heating or cooling zones 54 and one or more heat pumps 56 or chillers to transfer heat to or from the heating or cooling zones 54 (e.g., a single heat pump, one heat pump for each building zone, one heat pump for multiple building zones, one heat pump for each well or heat exchange loop, one heat pump for multiple wells or loops, etc.). The heat pumps or chillers 56 and ventilation fans 58 may be individually controlled and actuated by the HVAC system 34 depending on the heating and/or cooling needs of each building zone 54.

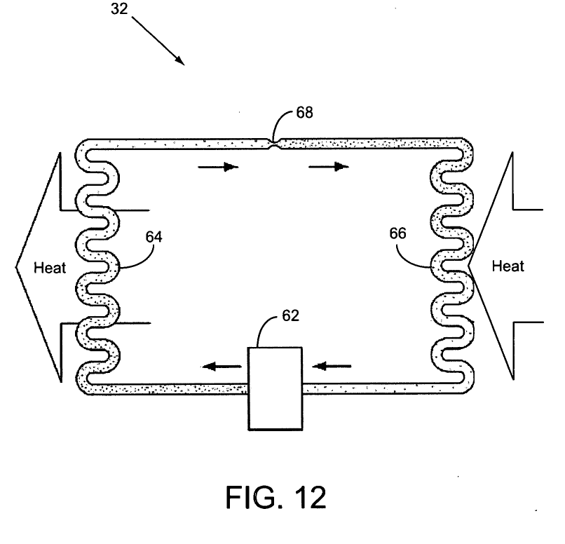

Referring to FIG. 12, a schematic diagram of a heat pump 32 illustrates how a heat pump functions according to an exemplary embodiment. The compressor 62 moves a refrigerant through the heat exchange coils acting as a condenser 64 for condensing the fluid into a higher pressure liquid to discharge heat. The heat pump 60 also includes an evaporator 66 allowing the low pressure fluid to change from liquid to a gas state to absorb heat. The condenser 64 and evaporator 66 are separated by an expansion valve 68 that facilitates the change in pressure between the coils. The pumped water of the remediation system 30 may flow past or over the condenser or evaporator to receive or provide heat, respectively.

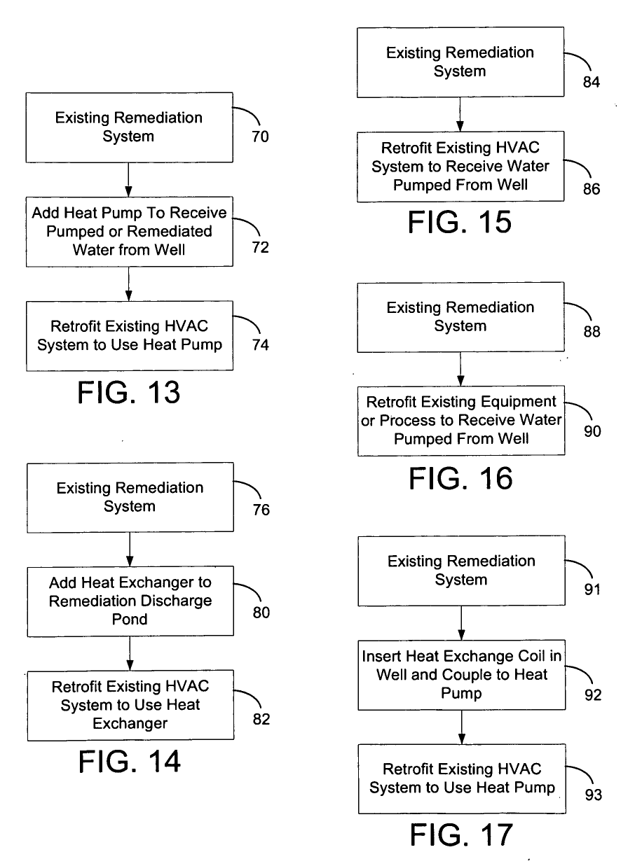

FIGS. 13-17 are process flow diagrams illustrating methods for converting a remediation system so that it is capable of geothermal heating and cooling, according to various exemplary embodiments. Referring to FIG. 13, according one exemplary embodiment, an existing remediation system is provided (step 70). A heat pump is added to the remediation system to receive pumped or remediated water (step 72). An existing HVAC system is then retrofitted to use the heat exchanger of the heat pump (step 74). Referring to FIG. 14, according one exemplary embodiment, an existing remediation system is provided (step 76). A heat exchanger is added to a remediation discharge pond (step 78). An existing HVAC system is then retrofitted to use the heat exchanger (step 82). Referring to FIG. 15, according one exemplary embodiment, an existing remediation system is provided (step 84). An existing HVAC system is then retrofitted to receive water pumped from the well (step 86). Referring to FIG. 15, according one exemplary embodiment, an existing remediation system is provided (step 88) An existing piece of equipment or process is then retrofitted to receive water pumped from the well (step 90). Referring to FIG. 17, according one exemplary embodiment, an existing remediation system is provided (step 91). A heat exchange coil is inserted into the well and is coupled to a heat pump (step 92). An existing HVAC system is then retrofitted to use the heat exchanger of the heat pump (step 93).

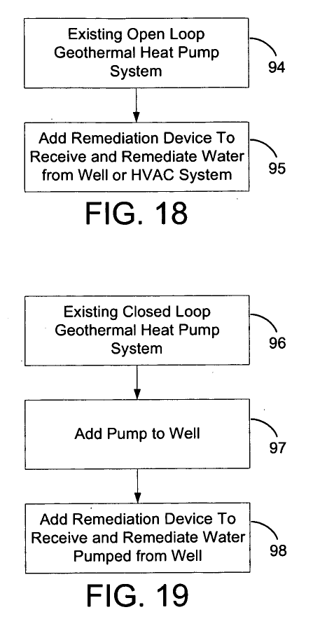

FIGS. 18-19 are process flow diagrams illustrating methods for converting a geothermal heating and cooling system so that is capable of water remediation, according to various exemplary embodiments. A remediation device may be added to the water flow to treat or contain the water before or after heat exchange occurs for treatment or containment. Referring to FIG. 18, according one exemplary embodiment, an existing open loop geothermal exchange system is provided (step 94). A remediation device is added to the geothermal system to receive and remediate pumped water from a well or HVAC system (step 95). Referring to FIG. 19, according one exemplary embodiment, an existing closed loop geothermal exchange system is provided (step 96). A pump is added to the well (step 97). A remediation device is added to the geothermal system to receive and remediate pumped water from the well (step 98).

While a single well 20 is illustrated in FIGS. 2-9, according to other exemplary embodiments more than one well 20 may be used to pump water to the remediation system 30 and/or geothermal exchange system 50. While the heat pump 32 is shown to be separate from the HVAC system 34 in the schematic diagrams of FIGS. 2-5 and 9 for illustrative purposes, an HVAC system may include one or more heat pumps or similar heating and cooling equipment. While the heat pump 32 in FIGS. 2-5 and 9 appears to receive all of the pumped or remediated water, according to other exemplary embodiments, the heat pump 32 may only receive a portion of the pumped or remediated water while the rest is discharged or used for other functions. It is noted that according to various exemplary embodiments, the volume of water flowing to the heat pump 32, HVAC system 34, equipment and/or process 38 may be controlled by an electronic control unit or process based on the cooling or heating needs of at least one zone in the building. While FIGS. 9-12 illustrate a specific number of heat exchange loops or coils, according to other exemplary embodiments any number of heat exchange loops or coils may be used to transfer heat. While various exemplary embodiments described use a heat pump, it is noted that according to other exemplary embodiments, a chiller could be used instead of the heat pump. According to various exemplary embodiments, the HVAC system in the building may be any preexisting HVAC system capable of being retrofitted to receive heat from and/or transmit heat to a heat pump, any preexisting HVAC system capable of being retrofitted to receive pumped or remediated water for heating and/or cooling the building 10, or any HVAC system specially designed to use a remediation system.

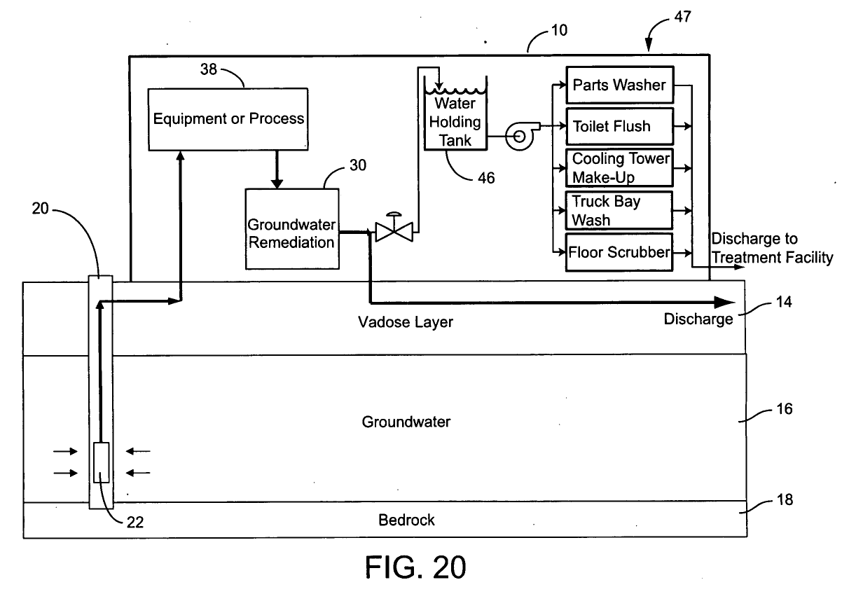

Referring to FIG. 20, the building 10 may use pumped water to cool or heat equipment or a process 38 in the building 10, according to an exemplary embodiment. The building 10 may not include a heat pump, but the water may be pumped directly to equipment or to a process 38 that is to be cooled or heated (e.g., a manufacturing or industrial process, a machine requiring cooling, a battery requiring heating and/or cooling, etc.). The water remediation system 30 receives water from the equipment or process 38 for treatment or containment. Any treated water is discharged back into the groundwater layer 16, for example by discharge onto the ground surface 12 (e.g., into a drain or pipe, back into the well, into a pond, etc.), or to a water holding tank 46. Water stored in the holding tank 46 can be used with other building equipment or for other building processes 47, for example for washing parts, for flushing a toilet, for use by a cooling-tower, for use in a truck bay washing area, for use by a floor scrubber, etc. After use by the additional processes or equipment 47, the water can be discharged to a wastewater treatment facility. As much water as may be needed for these processes and equipment may be diverted to the holding tank 46.

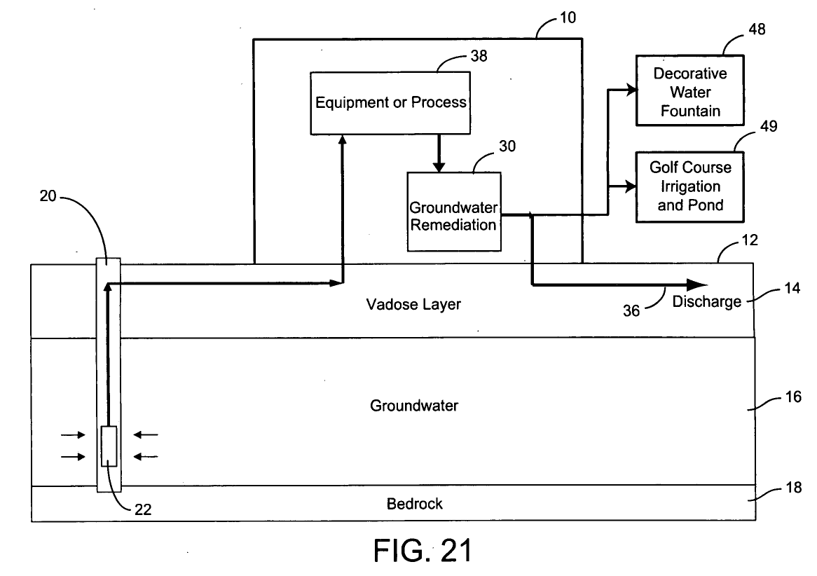

Referring to FIG. 21, the building 10 may use pumped water to cool or heat equipment or a process 38 in the building 10, according to an exemplary embodiment. The building 10 may not include a heat pump, but the water may be pumped directly to equipment or to a process 38 that is to be cooled or heated (e.g., a manufacturing or industrial process, a machine requiring cooling, a battery requiring heating and/or cooling, etc.). The water remediation system 30 receives water from the equipment or process 38 for treatment or containment. Any treated water can be discharged back into the groundwater layer 16, for example by discharge onto the ground surface 12 (e.g., into a drain or pipe, back into the well, into a pond, etc.), for use in a decorative water fountain 48, for use with a golf course irrigation system or pond 49, etc. The water diverted to the fountain 48 or golf course 49 may not need to be returned to the groundwater or a treatment facility because it may generally be evaporated or consumed through irrigation. The use of remediated water in a fountain 48 or irrigation system 49 may save the use of water from a fresh water supply (e.g., from a water treatment plant, a reservoir, a water tower, etc.). The remediated water may also be sold to other sites, for example an irrigation system.

Referring back to FIG. 1, the building 10 may include a building automation system (BAS). A BAS, in general, includes hardware and/or software systems configured to control, monitor, and manage equipment in or around a building or building area. BAS equipment can include a heating, ventilation, and air conditioning (HVAC) system, a security system, a lighting system, a fire alerting system, an elevator system, another system that is capable of managing building functions, or any combination thereof. A BAS as illustrated and discussed in the disclosure is an example of a facility system that may be used in conjunction with geothermal heat exchange and water remediation; however, other facility management systems may be used as well. According to other exemplary embodiments, the BAS may be used in conjunction with any type of system (e.g., a general purpose office local area network (LAN), a home LAN, a wide area network (WAN), a wireless hotspot, etc.).

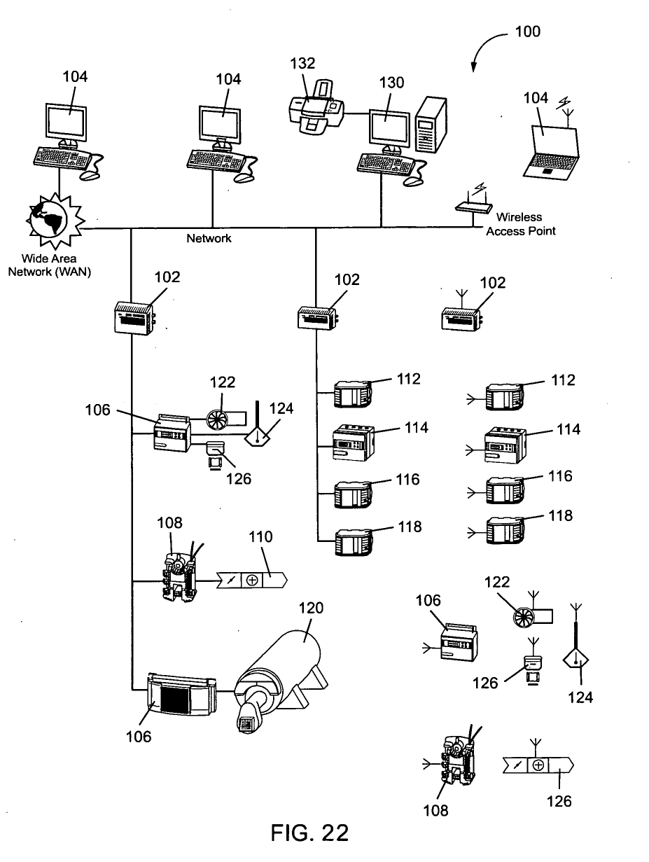

Referring to FIG. 22, a schematic diagram of a BAS 100 that may be used with the systems and methods of the present disclosure is shown, according to an exemplary embodiment. BAS 100 may include one or more supervisory controllers (e.g., a network automation engine (NAE)) 102 connected to a proprietary or standard communications network such as an IP network (e.g., Ethernet, WiFi, ZigBee, Bluetooth, etc.). Supervisory controllers 102 may support various field-level communications protocols and/or technology, including various Internet Protocols (IP), BACnet over IP, BACnet Master-Slave/Token-Passing (MS/TP), N2 Bus, N2 over Ethernet, Wireless N2, LonWorks, ZigBee, and any number of other standard or proprietary field-level building management protocols and/or technologies. Supervisory controllers 102 may include varying levels of supervisory features and building management features. The user interface of supervisory controllers 102 may be accessed via terminals 104 (e.g., web browser terminals) capable of communicably connecting to and accessing supervisory controllers 102. For example, FIG. 2 shows multiple terminals 104 that may variously connect to supervisory controllers 102 or other devices of BAS 100. For example, terminals 104 may access BAS 100 and connected supervisory controllers 102 via a WAN, an Internet location, a local IP network, or via a connected wireless access point. Terminals 104 may also access BAS 100 and connected supervisory controllers 102 to provide information to another source, such as printer 132.

Supervisory controllers 102 may be connected to any number of BAS devices. The devices may include, among other devices, devices such as field equipment controllers (FECs) 106 such as field-level control modules, variable air volume modular assemblies (VMAs) 108, integrator units, room controllers 110, 112 (e.g., a variable air volume (VAV) device or unit such as a VAV box), other controllers 114, unitary devices 116, zone controllers 118 (e.g., an air handling unit (AHU) controller), boilers 120, fan coil units 122, heat pump units 124, unit ventilators 126, expansion modules, blowers, temperature sensors, flow transducers, other sensors, motion detectors, actuators, dampers, heaters, air conditioning units, etc. These devices may generally be controlled and/or monitored by supervisory controllers 102. Data generated by or available on the various devices that are directly or indirectly connected to supervisory controllers 102 may be passed, sent, requested, or read by supervisory controllers 102 and/or sent to various other systems or terminals 104 of BAS 100. The data may be stored by supervisory controllers 102, processed by supervisory controllers 102, transformed by supervisory controllers 102, and/or sent to various other systems or terminals 104 of the BAS 100. As shown in FIG. 2, the various devices of BAS 100 may be connected to supervisory controllers 102 with a wired connection or with a wireless connection.

Still referring to FIG. 22, an enterprise server 130 (e.g., an application and data server (ADS)) is shown, according to an exemplary embodiment. Enterprise server 130 is a server system that includes a database management system (e.g., a relational database management system, Microsoft SQL Server, SQL Server Express, etc.) and server software (e.g., web server software, application server software, virtual machine runtime environments, etc.) that provide access to data and route commands to BAS 100. For example, enterprise server 130 may serve user interface applications. Enterprise server 130 may also serve applications such as Java applications, messaging applications, trending applications, database applications, etc. Enterprise server 130 may store trend data, audit trail messages, alarm messages, event messages, contact information, and/or any number of BAS-related data. Terminals may connect to enterprise server 130 to access the entire BAS 100 and historical data, trend data, alarm data, operator transactions, and any other data associated with BAS 100, its components, or applications. Various local devices such as printer 132 may be attached to components of BAS 100 such as enterprise server 130.

The building automation system 100 may be used to control the water remediation system 30 and/or geothermal system 50 by controlling variable speed pumps to save energy, running scrubbers only when the flow demands, remotely controlling alarms, automatically shutting down under certain conditions (e.g., river level too high for discharge), generating automatic reports on flow, controlling pressures, controlling temperatures, etc.

The construction and arrangement of the geothermal heat exchange systems and water remediation systems shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, elements shown as integrally formed may be constructed of multiple parts or elements (e.g., the evaporator and condenser in FIG. 12 may be further separated or distributed), the position of elements may be reversed or otherwise varied (e.g., the pump in FIG. 1 may be in other locations), and the nature or number of discrete elements or positions may be altered or varied (e.g., there may be more or fewer wells than shown in FIG. 1). Accordingly, all such modifications are intended to be included within the scope of the present disclosure. The order or sequence of the method steps may be varied or re-sequenced according to alternative embodiments. Other substitutions, modifications, changes and omissions may be made in the design, operating conditions and arrangement of the exemplary embodiments without departing from the scope of the present disclosure.

What is claimed is:

1. A method of treating contaminated groundwater and controlling the temperature of a building, comprising:
providing water remediation equipment and a heat pump;
pumping water to be remediated from a well to ground level;
treating the water with the water remediation equipment;
providing the water to the heat pump to serve as a heat source or a heat sink; and
discharging the water.

2. The method of claim 1, wherein the water is discharged to a retention pond.

3. The method of claim 1, wherein the heat pump comprises a heat exchanger submerged in the retention pond.

4. The method of claim 1, wherein the water is discharged back to the well.

5. The method of claim 1, wherein the water is discharged to another treatment facility.

6. The method of claim 1, further comprising a building automation system configured to control the heat pump.

7. A method of retrofitting building equipment and a water remediation system to reduce the cost of operating the building equipment, comprising:
providing water piping;
coupling the water piping to a water remediation system used to treat contaminated water;
coupling the water piping to the building equipment; and
retrofitting the building equipment to use the water as at least one of a heat source or a heat sink.

8. The method of claim 7, wherein the building equipment comprises a HVAC system.

9. The method of claim 8, further comprising:
adding a heat pump to the building; and
retrofitting the existing HVAC system to use the heat pump.

10. The method of claim 8, further comprising:
adding a heat exchanger to a remediation discharge pond; and
retrofitting the HVAC system to use the heat exchanger as a heat source or a heat sink.

11. The method of claim 8, further comprising retrofitting the HVAC equipment to receive water pumped from a well.

12. The method of claim 8, wherein the HVAC equipment comprises an air handling unit and the water is used as a heat sink for the air handling unit.

13. The method of claim 7, wherein the building equipment comprises a heat pump and the water is utilized as a heat source or a heat sink for the heat pump.

14. The method of claim 13, further comprising a building automation system configured to control the heat pump.

15. The method of claim 7, wherein the building equipment comprises power production equipment and the water is used as a heat sink for the power production equipment.

16. A geothermal heat pump and water remediation system, comprising:
a well used as a source of water;
a water remediation system configured to treat the water; and
a heat pump configured to heat or cool a building, wherein the heat pump uses the water as at least one of a heat source or a heat sink.

17. The system of claim 15, further comprising a building automation system configured to control the heat pump.

18. The system of claim 15, further comprising a retention pond configured to hold the water after treatment.

19. The system of claim 15, wherein the heat pump comprises a heat exchanger submerged in the retention pond.

20. The system of claim 15, wherein the building comprises multiple spaces and the system further comprises one or more additional heat pumps configured to providing heating or cooling to the spaces, the additional heat pumps using the water as at least one of a heat source or a heat sink.

21. The system of claim 15, wherein the building automation system is configured to control each of the additional heat pumps.
